(19) United States
(12) Patent Application Publication
(10) Pub. No.: US 2024/0275013 A1
(43) Pub. Date: Aug. 15, 2024

(54) MULTI-MODE WAVEGUIDE AND WAVEGUIDE DEVICE

(71) Applicant: Oxford University Innovation Limited, Oxford (GB)

(72) Inventor: Mustafa BAKR, Oxford (Oxfordshire) (GB)

(21) Appl. No.: 18/569,708

(22) PCT Filed: Jun. 16, 2022
(86) PCT No.: PCT/GB2022/051525

§ 371 Date: Dec. 13, 2023

(30) Foreign Application Priority Data
Jun. 18, 2021 (GB) 2108762.2

(51) Int. Cl. H01P 1/208; H01P 3/123

(52) U.S. Cl. CPC H01P 1/2082; H01P 3/123

(57) ABSTRACT

A multi-mode waveguide is provided, the waveguide configured to support at least two degenerate modes of electromagnetic fields. The waveguide comprises an input node configured to couple electromagnetic fields into the waveguide. An output node is configured to couple electromagnetic fields out of the waveguide. A perturbation is configured to couple the two degenerate modes within the waveguide. The input node and the output node are positioned such that coupled degenerate modes clockwise and counter-clockwise propagating waves within the waveguide with at least two transmission minima. A waveguide device comprising a plurality of such multi-mode waveguides is also provided, the waveguide device having a plurality of transmission minima.

The present invention relates to multi-mode waveguides, to devices comprising n multi-mode waveguides, and to a method of filtering one or more frequencies from an electromagnetic field.

Waveguides are used in a variety of applications, notably in communications filtering, especially for satellite communications. The increasing capacity, complexity, and RF power in satellite communication demands the use of microwave filters with reduced size and volume. This requires the use of microwave filters incorporating real-frequency transmission zeros to meet the stringent specifications with reduced number of resonators, and thus, reduced volume and size. Traditionally, two different techniques are used to design filters with N real-frequency transmission zeros. The first one involves introducing a direct coupling between the source and load of the structure or the use of nonresonating modes as in over-moded cavities. The second technique consists of dangling resonators to extract N transmission zeros in a ladder network configuration.

Dual-mode and multi-mode filters within a single physical cavity are widely used in communication systems to introduce further size and volume reduction. Conventional dual-mode architectures, circular or rectangular waveguides, realise a pseudo-elliptic filtering function where the number of allowable transmission zeros with respect to transmission poles is limited, especially as the order N increases.

Dual-mode filters are based on two degenerate polarised modes within the same cavity rather than two different modes within the cavity. The two modes have the same indices and exist independently, that is orthogonal, until the symmetry is broken, i.e. the modes are coupled by some means that perturbs the fields. Similarly multi-mode filters comprise a multiple number of degenerate polarised modes.

In conventional inline multi-mode filters, the modes of the cavities are coupled in folded configuration which require cross-couplings for real-frequency transmission zeros. The number of transmission zeros are limited as the order N increases. In addition, the filter requires extensive optimisation and tuning due the difficulty in implementing the weak cross-couplings and simultaneously maintaining the proper polarisations of the modes.

To overcome these issues, over-moded TM dual-mode cavities, that provide N transmission zeros by operating at higher-order resonant modes and exploiting non-resonating modes, have been proposed. However, the use of over-moded cavities results in an increase in size, volume, and poor spurious performance in the stopband.

It is an object of the disclosure to provide multi-mode waveguides that do not rely on over-moded cavities, and/or to at least partially address one or more of the above-mentioned problems.

In accordance with a first aspect of the present invention there is provided a multi-mode waveguide, the waveguide configured to support at least two degenerate modes of electromagnetic fields, the waveguide comprising: an input node configured to couple electromagnetic fields into the waveguide; an output node configured to couple electromagnetic fields out of the waveguide; a perturbation configured to couple the at least two degenerate modes within the waveguide; wherein the input node and the output node are positioned such that the coupled degenerate modes form clockwise and counter-clockwise propagating waves within the waveguide with at least two transmission minima. For example, the multi-mode waveguide may be a dual-mode waveguide, or a triple-mode waveguide.

In conventional inline dual mode waveguides, the input and output nodes are located in first and second ends respectively. The inputs and outputs are spaced approximately half a wavelength apart. In contrast, in the present invention uses clockwise and counter-clockwise rotating waves, i.e. waves with at least a component of polarisation that rotates. Such waves may be considered to be azimuthally propagating. Further, depending on the shape of the waveguide and the specific degenerate modes used, the waves may be considered to be circularly, elliptically, cylindrically, or spherically propagating. The phase relationship between these propagating modes determines the positioning of transmission minima by creating destructive interference between multiple paths. The position and/or orientation of the input and output nodes plays a primary role in controlling the phase between the degenerate modes. Thus the present invention provides waveguides with multiple transmission minima, which can be designed for needs of a particular applications by appropriate positioning of the input and output nodes. Furthermore, because the invention uses rotating waves, the input and output nodes do not need to be in opposing ends of the waveguide, as in conventional waveguides. This means waveguides can be stacked in parallel, forming a more compact filter than is possible in conventional systems. Furthermore, the input and output nodes can be spaced longitudinally less than half a wavelength apart. The waveguides of the present invention thus provide multi-mode filtering, without making use: of dangling resonators; direct coupling between the input and the output of the filter; over-moded cavities; or cumbersome cross-couplings, as used in conventional architecture. The waveguides of the present invention provide high quality-factor filtering in a much more compact, and hence lightweight, form than conventional systems. As such, the waveguides may be particularly useful in filtering satellite communications, where low weight and high quality are important considerations. It is noted that although described herein as having two/multiple transmission minima, the waveguide may also have two/multiple reflection minima formed by the same process as the transmission minima. Combinations of waveguides may thus have N reflection minima. As used herein, transmission minima refers to frequencies at which the transmission response of the waveguide is a minimum or local minimum.

As used herein, the position of the nodes may include the spatial position of the nodes, and/or the rotation of the nodes with respect to one or more axes of the waveguide.

In some embodiments, the transmission minima are real-frequency transmission minima. In other words, the transmission zeros are on the imaginary axis in the s-plane. Thus the waveguide may be used to filter two or more frequencies from electromagnetic waves passing through the waveguide.

In some embodiments, the transmission minima are complex-frequency transmission minima (or imaginary transmission minima). In other words, the transmission minima on the complex (or real) axis in the s-plane. Thus the waveguide may be used to provide group delay equalisation of waves passing through the waveguide (i.e. improving the linearity and/or reducing distortion of information in time domain).

In some embodiments, the input node and the output node are positioned such that an angle (e.g. an azimuthal angle) between a first vector from the input node to a centre point of the waveguide and a second vector from the centre point to the output node is less than 170°, or is 120° or less, or is 90° or less, such that the coupled degenerate modes form the clockwise and counter-clockwise propagating waves within the waveguide with the at least two transmission minima. The centre point is the geometrical centre of an internal volume of the waveguide. In contrast, conventional waveguides have an input and output separated by 180°, so that waves propagate linearly between the input and output. The present inventions allows the input and output node to be closer together than in conventional arrangements, allowing waveguides to be stacked in more compact arrangements than is conventionally possible. The first vector may be a vector to a geometrical centre of the input node. The second vector may be a vector to a geometrical centre of the output node.

In some embodiments, the position of the input node and the output node is selected based on desired frequencies for the two or more minima. By selecting the angle appropriately, the frequency minima can be tuned with respect to the resonant frequency of the waveguide. For example, the angle between the input and output node may be selected based on the desired frequencies.

In some such embodiments, the desired frequencies are symmetric with respect to a resonant frequency of the waveguide. The physical symmetry may make waveguide design and production simpler. However in alternative embodiments, the desired frequencies are asymmetric with respect to a resonant frequency of the waveguide.

In some embodiments, the input node and output node are at the same position along a longitudinal axis, the longitudinal axis extending the length of the waveguide for example extending between a first end and a second end. For spherical waveguides the longitudinal axis may be a central axis of the sphere. Such embodiments provide a particularly compact and simple design, especially when waveguides are to be cascaded (i.e. an output iris coupled to an input iris of a subsequent waveguide in the cascade). In general, the input node and the output node may be separated along the longitudinal axis by less than half of a resonant wavelength of the waveguide. Thus the longitudinal length of the waveguide may be less than that of conventional inline dual-mode filters, which are connected end-to-end.

In some embodiments, the waveguide comprises a first end, a second end, and at least one sidewall connecting the first end and the second end. At least one of the input node and the output node is located in the at least one sidewall.

In some embodiments, the perturbation comprises a perturbation structure extending at least a majority of the length of the waveguide between the first end and the second end (or more generally a majority of a length along a longitudinal axis of the waveguide). The perturbation breaks the symmetry of the orthogonal modes of the waveguide, and so provides for the real- or complex-frequency transmission minima. Using a perturbation structure provides this perturbation whilst allowing the overall design of the waveguide to retain symmetry. This may facilitate design and manufacture of the waveguide.

In some embodiments, the perturbation is provided by an asymmetry in a cross-section of the waveguide, the cross-section perpendicular to a longitudinal axis, the longitudinal axis for example extending the length of the waveguide between the first end and the second end. For example, a rectangular cross-section may be used, where the asymmetry in the width and height of the waveguide provides the asymmetry.

In some embodiments, the azimuthal angle between the perturbation structure and the input node is equal to the azimuthal angle between the perturbation structure and the output node. In such embodiments the transmission minima may be real-frequency transmission minima.

In some embodiments, the azimuthal angle between the perturbation structure and the input node is less than or more than the azimuthal angle between the perturbation structure and the output node. In such embodiments the transmission minima may be complex-frequency transmission minima.

In some embodiments the fundamental resonant frequency of the waveguide is in the microwave range of the electromagnetic spectrum. Thus the waveguide may act as a microwave filter, which is particularly useful for satellite communications. The microwave range may be considered 0.3 to 300 GHz. In some embodiments, the fundamental resonant frequency of the waveguide is in the range from 1 GHz to 40 GHz inclusive. The fundamental resonant frequency may be in a defined satellite communications band, such as the L-, C-, X-, Ku-, or Ka bands.

According to a second aspect of the invention there is provided a multi-mode waveguide, the waveguide configured to support at least two degenerate modes of electromagnetic fields, the waveguide comprising: an input node configured to couple electromagnetic fields into the waveguide; an output node configured to couple electromagnetic fields out of the waveguide; a perturbation configured to couple the at least two degenerate modes within the waveguide; wherein the input node and the output node are positioned such that an angle between a first vector from the input node to a centre point of the waveguide and a second vector from the centre point to the output node is less than 170°, wherein the centre point is the geometrical centre of an internal volume of the waveguide, such that the coupled degenerate modes form a wave within the waveguide with at least two transmission minima. Waveguides of the second aspect may comprise the features of any embodiment of the first aspect discussed above or below.

According to a third aspect of the invention, there is provided a waveguide device comprising a plurality of waveguides (i.e. n waveguides), each of the n waveguides being a waveguide according to any embodiment of the first or second aspects, wherein the n waveguides are connected in a cascade in which the output node each waveguide in the cascade is coupled to the input node of the subsequent waveguide in the cascade to form a waveguide device a plurality of transmission minima. For example, in waveguides with two transmission minima, the waveguide device has a total of N 2n real- or complex-frequency transmission minima. As discussed above, such a device can be more compact than conventional inline dual-mode filters. The device provides high-quality filtering of a plurality of frequencies, which can be selected by appropriate design of each of the individual waveguides forming the cascade. The waveguides of the cascade may all have the same number of transmission minima, or may have different numbers of transmission minima.

In some embodiments the device is (or is part of) a waveguide filter, a polarizer, a multiplexer, a balance network, a directional coupler, and/or a filtering antenna.

According to a fourth aspect of the invention there is provided a method of filtering one or more frequencies from an electromagnetic field, the method comprising coupling the electromagnetic field into a waveguide of any embodiment of the first aspect or second aspect, or into a waveguide device according to any embodiment of the third aspect.

To allow better understanding, embodiments of the present invention will now be described by way of non-limitative example with reference to the accompanying drawings, in which:

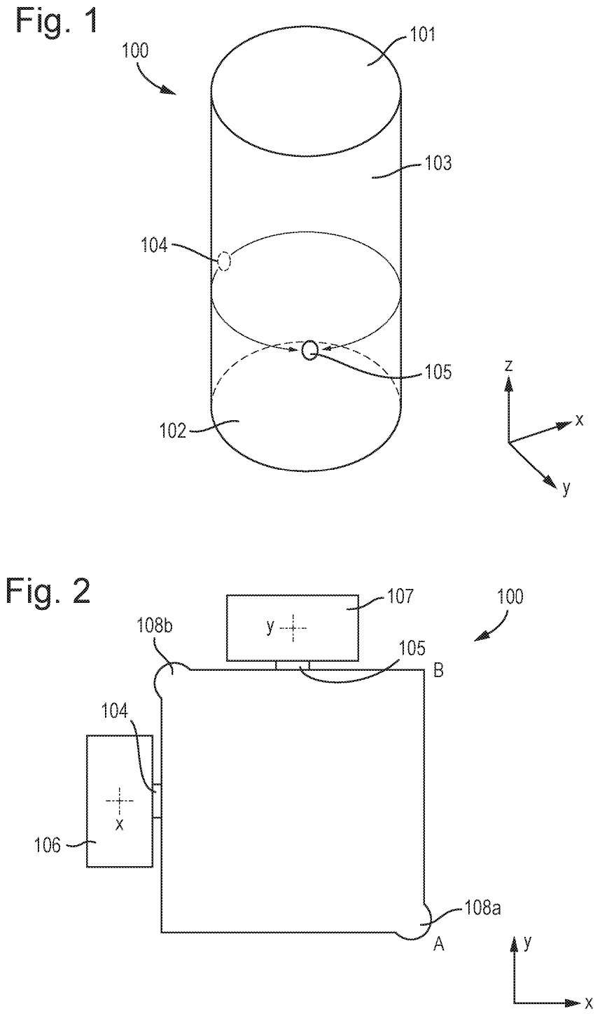

FIG. 1 illustrates an example of a dual-mode waveguide;

FIG. 2 illustrates a further example of a waveguide;

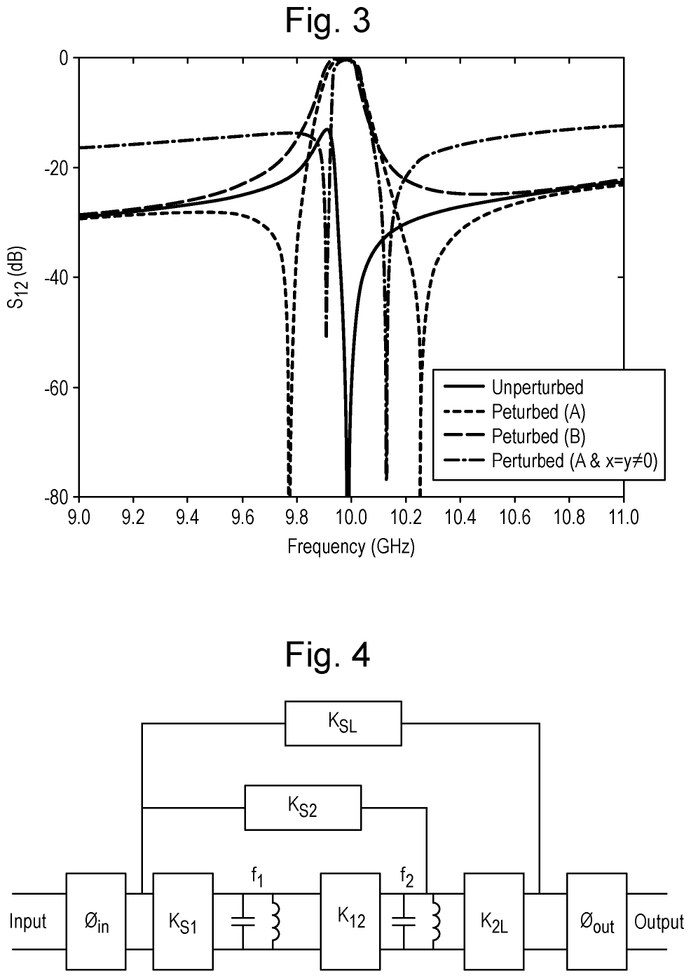

FIG. 3 illustrates filter responses of the waveguide of FIG. 2, with varying perturbations;

FIG. 4 illustrates an equivalent circuit for the waveguide of FIG. 2;

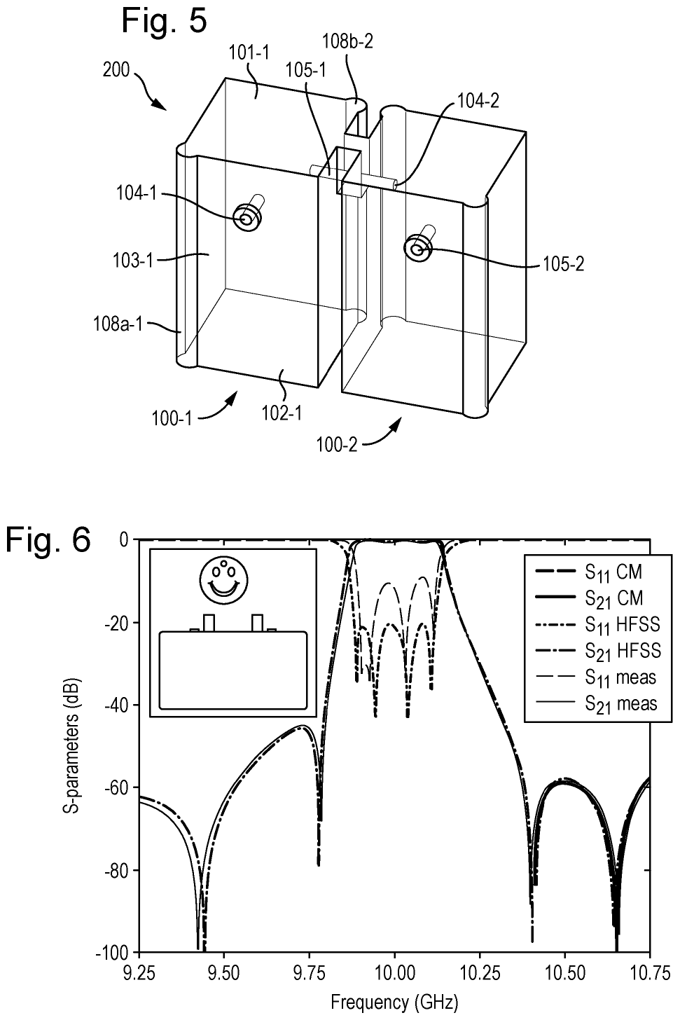

FIG. 5 illustrates a waveguide device comprising multiple waveguides;

FIG. 6 illustrates the filtering response of the device of FIG. 5;

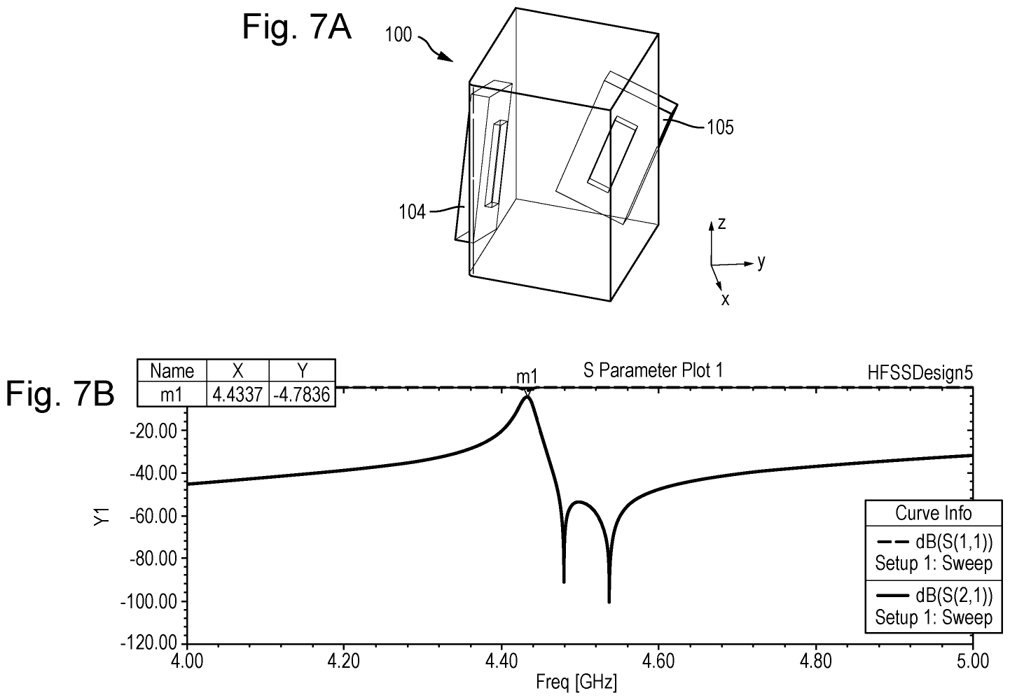

FIG. 7A illustrates an alternative waveguide, with rotated input and output nodes;

FIG. 7B illustrates the filtering response of the waveguide of FIG. 7A;

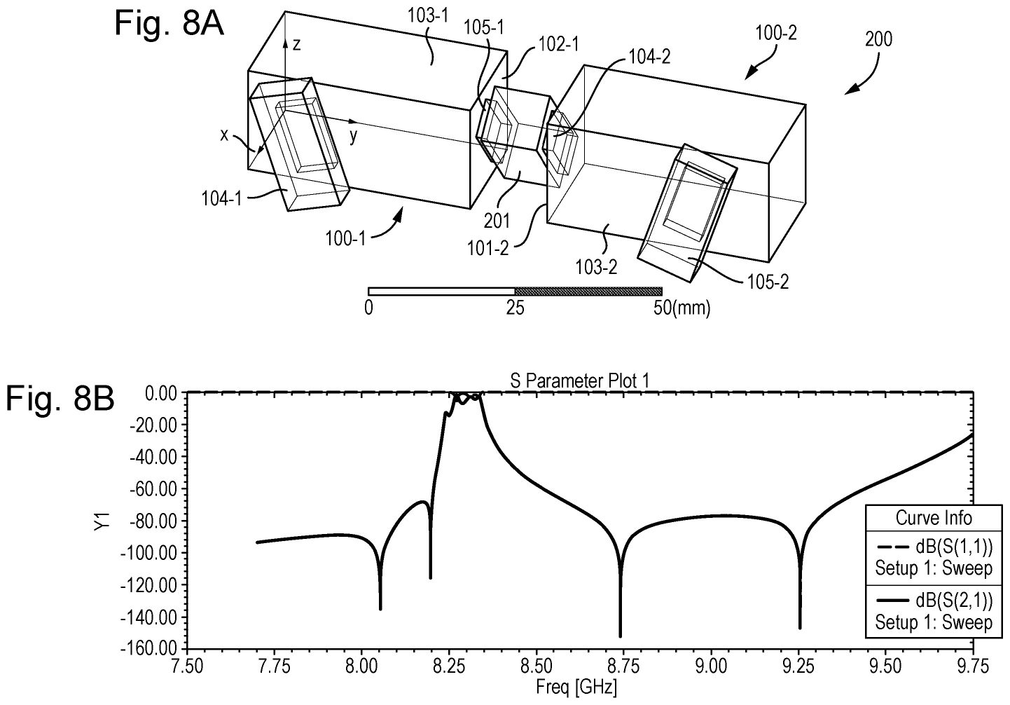

FIG. 8A illustrates a waveguide device comprising multiple waveguides with rotated input and output nodes;

FIG. 8B illustrates the filtering response of the device of FIG. 8A;

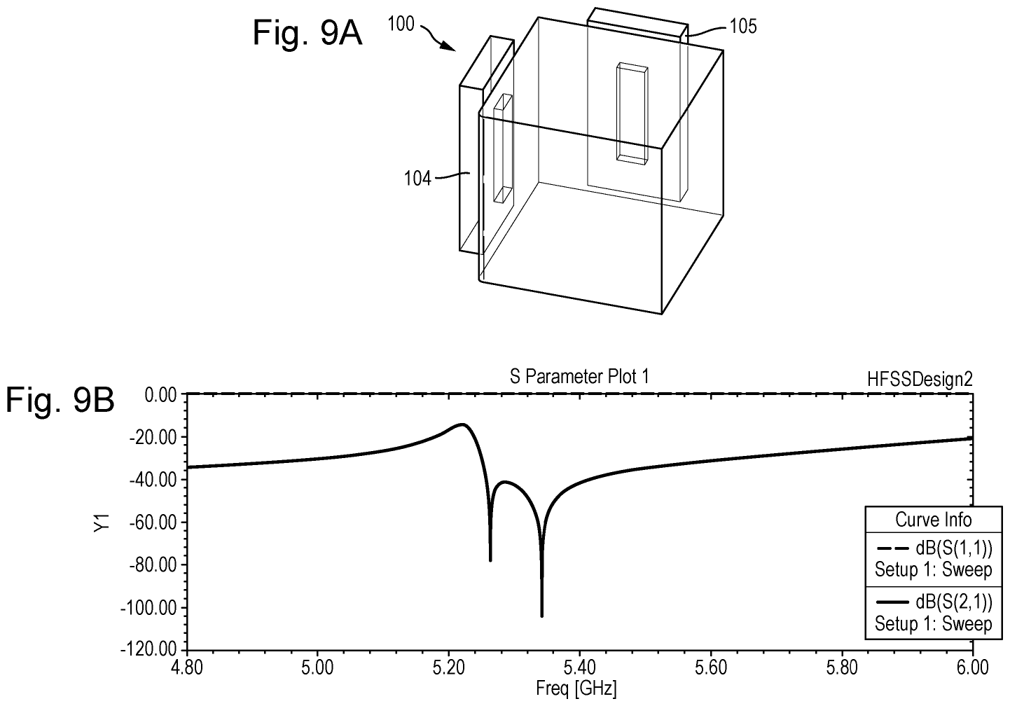

FIG. 9A illustrates a cubic waveguide;

FIG. 9B illustrates the filtering response of the waveguide of FIG. 9A;

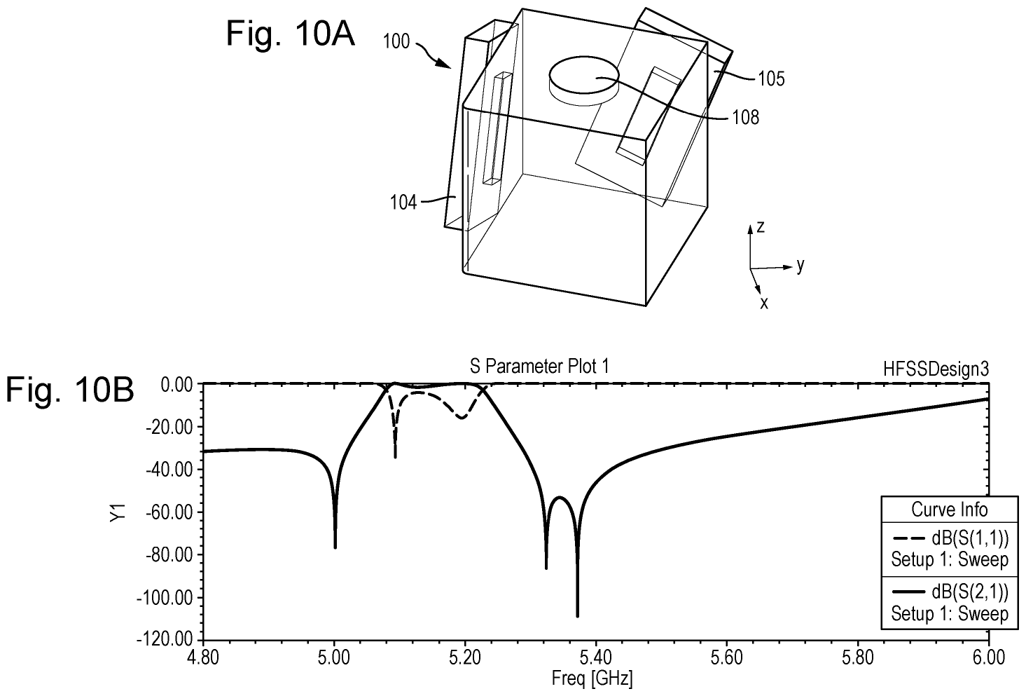

FIG. 10A illustrates a cubic waveguide with rotated input and output nodes;

FIG. 10B illustrates the filtering response of the waveguide of FIG. 10A;

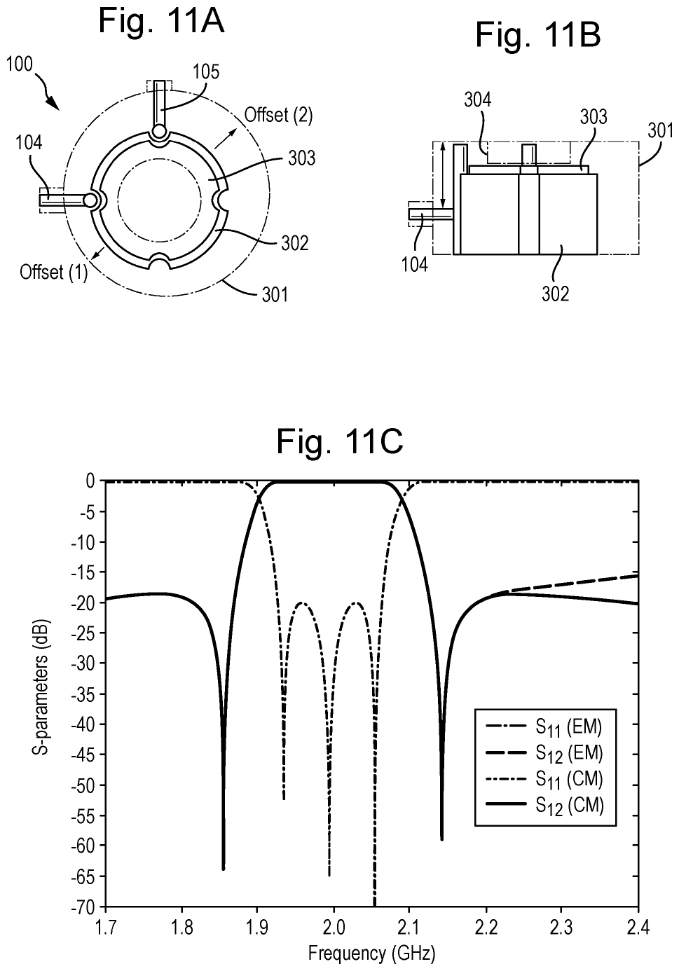

FIG. 11A illustrates a top-down view of an alternative waveguide comprising dielectric loaded cavities;

FIG. 11B is a side view of the waveguide of FIG. 11A;

FIG. 11C illustrates the filtering response of the waveguide of FIG. 11A; and

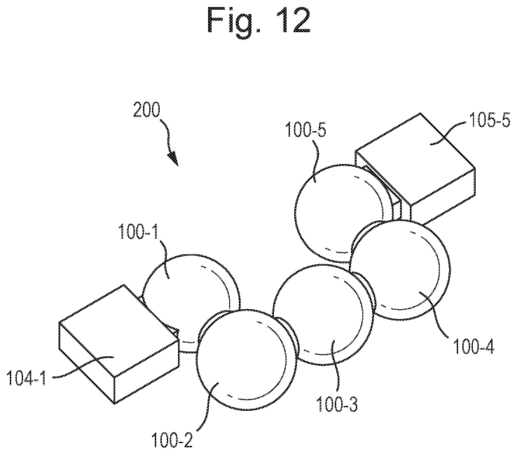

FIG. 12 illustrates a waveguide device comprising multiple spherical waveguides.

FIG. 1 illustrates an example arrangement of a waveguide 100. Waveguide 100 is a dual-mode waveguide, configured to support two degenerate modes of electromagnetic fields. In this example, the waveguide 100 is a cylindrical waveguide. That is, the shape of the waveguide is substantially cylindrical, with a substantially circular cross-section in a plane orthogonal to the longitudinal length of the waveguide 100 (the x-y plane). In other embodiments, the waveguide 100 may be shaped with a substantially elliptical, substantially square, or substantially rectangular cross-section in the plane orthogonal to the longitudinal length of the waveguide. It is noted that the waveguide 100 may comprise a perturbation structure (discussed below) which may add an irregularity to the cross-sectional shape of the waveguide 100. In such cases, the cross-sectional shapes referred to above may be the shapes when any such perturbation structures are ignored.

The waveguide 100 comprises a first end 101, a second end 102, and at least one sidewall 103 connecting the first end and the second end. As the illustrated example is a cylindrical waveguide, the at least one sidewall 103 comprises one continuous sidewall. In general, the number of sidewalls 103 will be determined by the cross-sectional shape of the waveguide 100. Thus for square or rectangular waveguides, the at least one sidewall 103 will comprise four sidewalls 103. Other examples of waveguides may not have ends and sidewalls, for example spherical waveguides.

Waveguide 100 further comprises an input node 104 and an output node 105. The input node 104 is configured to couple electromagnetic fields into the waveguide. The output node 105 is to couple electromagnetic fields out of the waveguide. The input and output nodes 104, 105 may take any form suitable for coupling electromagnetic waves, or electromagnetic waves of a desired frequency range, into/out of the waveguide 100. For example, the nodes 104, 105 may each comprise an iris or other aperture, a waveguide, a coaxial probe, and/or a transmission line of any shape. A maximal size of the opening of each iris/aperture (e.g. diameter for a circular iris/aperture) may be selected based on a desired coupling strength between the nodes 104, 105. The nodes 104, 105 may be comprise an opening, e.g. an inductive or capacitive iris (E or H-plane), with or without corrugated nodes or coaxial probes or loops (e.g. inductive transformers or coaxial loops). The nodes 104, 105 may have any shape, and their size can range up approximately the size (length or width) of the waveguide 100. The nodes 104, 105 may be centred or off-centred. As shown in FIG. 2 discussed below, one or both of the nodes 104, 105 may be attached or attachable to input and output waveguides 106, 107 respectively. The input/output waveguides 106, 107 may be used to transmit an EM wave to/from the respective node 104, 105. As discussed further below, the input node 104 and/or output node 105 in some examples is configured such that light entering/leaving the waveguide is misaligned with one or more axes of symmetry of the waveguide. In other words, the input node 104 and/or output node 105 may be rotated with respect to the main body of the waveguide 100.

In conventional waveguides, the input node 104 would be positioned in the first end 101, and the output node 105 would be positioned in the second end 102, so that waves propagate along the length of the waveguide from one end to the other. In contrast, the input node 104 and output node 105 of waveguides 100 of the present disclosure are positioned such that coupled degenerate modes in the waveguide form clockwise and counter-clockwise propagating waves. Depending on the shape of the waveguide 100, this propagation may be considered azimuthal, circular, elliptical, or spherical propagation. For example, this may be achieved by positioning the input node 104 and the output node 105 such that an angle between a first vector from the input node to a centre point of the waveguide and a second vector from the centre point to the output node is less than 170°. Here the centre point is the geometrical centre of an internal volume of the waveguide. This angle may be considered an azimuthal angle with respect to a primary axis of the waveguide 100.

In some example, such as that illustrated in FIG. 1, this positioning is achieved by one or both of input node 104 and output node 105 being located in the one or more sidewalls 103. In the illustrated cylindrical embodiment, both nodes 104, 105 are located in the single sidewall 103. In waveguides 100 in which the one or more sidewalls 103 comprise a plurality (e.g. four) sidewalls 103, the input node 104 may be located in a first sidewall 103 of the plurality of sidewalls 103. The output node 105 may be located in a second sidewall 103 of the plurality of sidewalls 103. The nodes 104, 105 may be otherwise positioned to couple waves into

When electromagnetic (EM) waves are coupled into the illustrated dual-mode waveguide 100 in FIG. 1, the waves propagate in two degenerate modes. The modes can be transverse electric (TE) or transverse magnetic (TM) waves. In conventional in-line dual-mode waveguides, the EM propagation polarisation is linear. In contrast, in waveguide 100 the two propagating modes exist in either co-rotations or counter rotations. That is the waves are circularly polarised, i.e. they have a rotating propagation in the x-y plane (the plane perpendicular to the length of the waveguide between first end 101 and second end 102). In general, the polarisation may be elliptical (of which circular is a specific example). In FIG. 1, the arrows between the input node 104 and output node 105 illustrate the two different directions of propagation in the x-y plane. The principle behind this is that the coupling between the input node 104 and the output node 105 will cause some TE power to be reflected from the output node 105. The reflected wave will have a polarisation 90° to the wave excited by the input node 104. The phase of this reflected wave may be different from that of the input so that, when adding with the input wave, some of the energy becomes circularly polarised. As a result of this propagation, coherent in-band combination and cancellations in the stopband are formed by the two modes. In other words, the coherent combination and cancellation causes the appearance of two reflection and transmission minima in each waveguide 100. Thus, by coupling an EM field into the waveguide 100, one or more frequencies can be filtered out by the stopband. The waveguide 100 therefore acts as an EM filter. Similarly, in example waveguides 100 with more than two degenerate modes, exciting waves with at least a component of polarisation that propagates clockwise and counter-clockwise provides more than two reflection and transmission minima. In general, the interplay between electromagnetic field components in the azimuthal (clockwise/counter-clockwise) direction and the longitudinal direction can be used to provide desired transmission minima.

In FIG. 1, the azimuthal angle between the input node 104 and the output node 105 is 90°. Here, the azimuthal angle is the angle between the nodes 104, 105 when projected into the x-y plane (the plane orthogonal to the length of the waveguide 100 between the ends 101, 102). In such examples, the azimuthal angle determines which frequencies are filtered by the waveguide 100. As discussed further below, when the waveguide is perturbed two frequency minima will be formed. The azimuthal angle determines the frequencies of the two frequency minima. In particular, the azimuthal angle determines the frequency difference between the frequency minima and a resonant frequency of the degenerate modes within the waveguide.

In the case of an azimuthal angle of 90°, the frequency minima will be symmetrically spaced with respect to the resonant frequency. Other embodiments may use a non-90° (and)non-180° angle to form asymmetrically spaced frequency minima. In general, the azimuthal angle between the nodes 104, 105 may be selected based on desired frequencies for the two real-frequency minima. In other words, the waveguide 100 is designed to filter specific frequencies.

Also as shown in FIG. 1, the input node 104 and output node 105 may be at the same position along a longitudinal axis. The longitudinal axis is the axis that extends the length of the waveguide between the first end 101 and the second end 102. In other embodiments, however, the input node 104 and the output node 105 may be separated along the longitudinal axis. Advantageously, this separation may be a distance of less than half of a resonant wavelength of the waveguide (i.e. the resonant frequency of the degenerate modes in the waveguide). This is in contrast to conventional in-line filters, where the spacing between the input and output nodes 104, 105, located in the respective ends 101, 102, is a half wavelength. Conventional filters therefore have a minimum size, which does not apply to the waveguides 100 of the present disclosure. This allows the present waveguides 100 to be made significantly more compact and lightweight than conventional filters. Indeed, the volume may be up to 60% less than for conventional waveguides.

Although not shown in FIG. 1, the waveguide 100 further comprises a perturbation. The perturbation is configured to couple the two degenerate modes within the waveguide 100. As noted above, this perturbation splits the frequency minimum formed by the co-rotating waves, yielding two real-frequency or complex-frequency transmission minima.

The perturbation may be provided by an asymmetry in the cross-section of the waveguide in the x-y plane. For example, where the cross-section is rectangular, the asymmetry between the length and width of the cross-section acts as the perturbation. In other words, the perturbation is provided by a deviation in the cross-sectional shape of the waveguide from a regular shape (the rectangle example being a deviation from a square). Alternatively (or additionally), the perturbation may comprise a perturbation structure extending at least a majority of the length of the waveguide 100 between the first end 101 and the second end 102. The perturbation structure is a discontinuity or irregularity in the shape of the cross-section in the x-y plane that causes the cross-sectional shape to deviate from a regular shape. The perturbation structure may extend away from the main body of the waveguide in the x and/or y directions (i.e. the directions orthogonal to the longitudinal length of the waveguide). For example, the perturbation structure may be a corner step extending from the corners of an otherwise square cross-sectioned waveguide. (When considered in three dimensions, the corner step is actually a step extending along a longitudinal edge of the square waveguide). FIG. 2 shows a waveguide 100 with such a perturbation structure. It is noted that the perturbation structure may be formed integrally with the main body of the waveguide; it does not need to be a separate component.

FIG. 2 shows a cross-section through a square waveguide 100 in the x-y plane. The waveguide 100 comprises a input node 104 in a first sidewall 103. An output node 105 is located in a second sidewall 103. Feeding waveguides 106, 107 are connected to a respective one of the input and output nodes 104, 105. The feeding waveguides 106, 107 are used to transport a wave to/from the nodes 104, 105. As shown below in relation to FIG. 4, feeding waveguides may also be used to connect multiple waveguides 100 together.

The waveguide further comprises perturbation structures 108a and 108b. The perturbation structures 108a, 108b take the form of an irregularity in the cross-sectional shape of the waveguide. In the particular example illustrated, the irregularity is a corner step extending from two corners of the waveguide 100. In other examples the perturbation structure may be a step or a cut extending into the waveguide 100. In the illustrated example, the perturbation structures 108a, 108b extend the full length of the waveguide 100 between the ends 101, 102. FIG. 2 comprises two perturbation structures 108a, 108b separated by an azimuthal angle of 180° in the x-y plane. In general, however, any number of perturbation structures may be used, including one (e.g. only comprising perturbation structure 108a).

The first degenerate resonant modes of the waveguide 100 of FIG. 2 are the TE101 and TE011 modes. The resonant frequency mode is given by:

$${f}_{TE} = {( {( \frac{m π c}{a} )}^{2} + {( \frac{n π c}{b} )}^{2} + {( \frac{p π c}{a} )}^{2} )}^{\frac{1}{2}} \qquad ( 1 )$$

where a is width (in the x direction, equal to height in the y direction) of the waveguide 100, and b is the length (in the z direction) of the waveguide 100. In particular examples, the length of the waveguide may be in the range from 3 cm to 10 cm or from 5 cm to 7 cm. The width may be in the range from 1 cm to 5 cm, or from 2 cm to 4 cm.

The waveguide 100 may be designed such that the fundamental (first) resonant frequency of the cavity is in the microwave range of the electromagnetic spectrum. This may be considered the range from 1 GHz to 300 GHz inclusive. As such, the waveguide may be particularly suited to communications uses, especially satellite communications.

FIG. 3 shows full-wave simulations of 10 GHz TE dual-mode cavities such as waveguide 100 of FIG. 2. In FIG. 3 the solid line shows the filter response without any perturbation. This has a single transmission minimum at approximately 10 GHz (and also a single transmission maximum). The broken lines show the response when the waveguide includes a perturbation.

Three perturbation cases are considered in FIG. 3. In the first, the waveguide 100 comprises perturbation structures 108a, 108b at the positions shown in FIG. 2. That is, a perturbation structure 108a is located at the corner marked A in FIG. 2. In this position, the azimuthal angle between the perturbation structure 108a and the input node 104 is (substantially) equal to the azimuthal angle between the perturbation structure 108a and the output node 105. In the specific illustrated example, both angles are 135°. The input node 104 and output node 105 are separated by 90°. The resulting filter response is shown in FIG. 3 by the line with short dashes. Two real-frequency minima are seen, positioned substantially symmetrically around the resonant frequency. The filter response is a 2nd order generalised Chebyshev function with two transmission zeros when the corner steps are at A.

The second perturbation case, the perturbation 108a is located as position B in FIG. 2. The second perturbation 108b is in the opposite corner, i.e. maintaining a 180° separation between the two perturbation structures 108a, 108b. In this case, the spacing between the input node 104 and output node 105 is still 90° (in other examples this spacing may vary, as discussed above). The filter response in this case is shown by the line with long dashes in FIG. 3. This is the dual case of corner steps at A, and the response is a 2nd order Chebyshev filter response without any real-frequency transmission zeros. That is the transmission zeros are purely imaginary, i.e. on the real axis in the s-plane. Imaginary (or complex) minima may be used for group delay equalization. In the illustrated example, the angle between the input node 104 and the perturbation structure 108a is 135°. The angle between the output node 108b and the perturbation structure 108a is 45°. An equivalent response could be achieved with an angle of 45° between the input node 104 and perturbation 108a, and of 135° between the output node 105 and the perturbation 108a. In general, where the azimuthal angle between the perturbation structure 108a and the input node 104a is less than or more than the azimuthal angle between the perturbation structure and the output node 105 the transmission minima are complex-frequency transmission minima. That is, when transformed into the s-plane, they have components on both the real and imaginary s-plane axes.

In the third perturbation case of FIG. 3, the perturbation 108a is again located at corner A in FIG. 2. However, the input node 104 and output node 105 are now separated by an azimuthal angle other than 90°. This separation may be any angle except 180° (which would result in only a single transmission minimum, even with a perturbation). In general, the perturbation structure 108a may be at any position, but for real frequency minima the angle between the perturbation structure 108a and the input/output nodes 104, 105 should be (substantially) equal. The resulting filter response is shown by the dotted and dashed line in FIG. 3. In this case, the transmission zeros are be brought closer to or further away from the passband edges (depending on the angle between the nodes 104, 105). If, alternatively, the perturbation structure was at corner B, an asymmetric filtering response, with real-frequency minima, would be achieved.

In any case, variations with frequency of the coupling of the input and output nodes, reactance, or susceptance, cause the response of the filter to be asymmetric, resulting thus asymmetric transmission zeros. Reactance or susceptance may be introduced or modified using non-resonating nodes connecting resonating sections of waveguide devices 200 formed of a plurality of waveguides 100 (waveguide devices 200 are discussed in more detail below). For example, they could be realised as a coaxial probe or loop transferring energy from the first waveguide 100 to the neighbouring waveguide 100. Another realisation is a section of waveguide resonating at a frequency above (or below) the frequency of the waveguide 100 (and coupled through irises or other forms).

In general, any perturbation that couples two or more degenerate modes within the waveguide may be used as the perturbation 108. In some examples, the perturbation 108 comprises one or more tuning elements, such as one or more tuning screws (or rods). The tuning elements/screws may be inserted into one or more sides of the waveguide 100. The tuning elements/screws may be inserted into the waveguide in either the longitudinal or transverse direction (with respect to the direction of propagation of waves in the waveguide 100). For example the tuning element/screws may be inserted into the waveguide in a side opposite the input node 104 and/or a side opposite the output node 105. The tuning element/screw may be inserted into a top or bottom side of the waveguide 100 (i.e. a side at an end of the longitudinal axis of the waveguide 100). In general, the tuning elements/screws may be inserted to align with an axis of symmetry of the waveguide 100. The tuning elements/screws break symmetry in the waveguide 100, and so control the frequency position of one or more transmission minima.

In some examples, the tuning elements/screws may be adjustable to control the coupling between degenerate modes in the waveguide. For example the depth of the tuning screws in the waveguide may be adjustable. This allows end-user control of the coupling between the degenerate modes, and hence control of the frequency properties of the waveguide 100. The tuning elements/screws may be dielectric or metallic. The tuning elements/screws may have any shape, such as cylindrical or arc shaped. In other examples, the tuning element (or generally the perturbation structure 108) comprises a metal cylinder/disc, as illustrated in FIG. 10A below.

FIG. 4 illustrates an equivalent circuit, based on resonance modes, for the waveguide 100 of FIG. 2. In this circuit, the phase shifters (ϕᵢₙ and ϕₒᵤₜ) and admittance inverters represent the input and output loads (susceptance) of the feeding waveguides and input/output nodes 104, 105. The two resonant modes are represented by LC networks with FIR nodes. The direct coupling between the non-resonating nodes, that is the input and output nodes 104, 105, is represented by an additional inverter K_{SL}. The cross-coupling K_{S2} between the input and the second resonator allows the control of transmission zeros and the realisation of asymmetric response: if the physical cavity is symmetric with respect to the corner steps an additional cross-coupling exists between the output and the first resonator with equal amplitude and opposite sign to KS2.

It is worth noting that the sign of input-output coupling can be positive or negative depending on the position of the corner steps with respect to the input and output feeding waveguides. In other words, the circular polarisation can change from clockwise to counter-clockwise depending on the position of the corner steps with respect to the input and output feeding waveguides.

The waveguides 100 discussed above have been shown as individual units. When used individually, a dual-mode waveguide 100 such as that of FIG. 1 can filter with two frequency minima. However, a plurality of n such waveguides 100 may be used in combination in a waveguide device, where n is any integer. For example, n may be in the range from 2 to 10, or from 10 to 100. In particular, the n waveguides 100 may be connected in a cascade, where the output node 105 of a first waveguide 100 is connected to an input node 104 of a second waveguide 100. The output 105 of the second waveguide 100 is connected to the input of a third waveguide 100, and so on. In such a cascade, only the input node 104 of the first waveguide 100 in the cascade, and the output node 105 of the final waveguide 100 in the cascade are unconnected to another waveguide 100. These nodes are used as the input and output respectively of the overall waveguide device. Each waveguide 100 in the cascade will have two transmission minima. The combination of waveguides 100 will therefore have N=2n transmission minima. By appropriately designing the waveguides 100 (i.e. waveguide dimensions, position of nodes 104, 105, position of perturbations), such a waveguide device can be designed to filter an arbitrary number of desired frequencies from an incoming EM field. Such a device may be used as a waveguide filter, a polarizer, a multiplexer, a balance network, a directional coupler, or a filtering antenna.

As the nodes 104, 105 are in the sidewalls of the waveguides 100, the waveguides can be connected side-by-side (i.e. in parallel). This is in contrast to conventional in-line filters, where waveguides must be connected in series (end to end), with additional couplings between the various waveguides. The waveguide device of the present disclosure can therefore be significantly more compact, and hence lightweight, than conventional filters. This makes it ideal for use in satellite communications, where lightweight filters with accurate filtering control are necessary.

FIG. 5 shows an example of a waveguide device comprising a first waveguide 100-1 and a second waveguide 100-2. Each waveguide 100-1, 100-2 is similar to that of FIG. 2. For clarity only some features are labelled in FIG. 5.

Waveguide 200 forms a 4-pole bandpass filter with four real-frequency transmission minima. The output node 105-1 of the first waveguide 100-1 and the input node 104-2 of the second waveguide 100-2 are connected together by a coaxial probe. Coaxial probes are also used to couple a wave into the device 200 via input port 104-1 of the first waveguide 100-1, and out of device 200 via second output port 105-2 of the second waveguide 100-2.

FIG. 6 shows the modelled and measured filtering response of the waveguide 200 of FIG. 4. The resonant frequency is taken to be 10 GHz. This achieve a 2.3% fractional bandwidth and four real-frequency transmission minima, clearly visible in FIG. 6 in both the modelled and real measurements. Device 200 exploits the fundamental dual-mode resonance of the waveguides 100-1, 100-2, and does not exploit the non-resonating nodes. In contrast to conventional in-line filters which require the input and output feeds located within the same cavity for N transmission zeros, the four symmetric transmission minima are obtained here by exploiting signal-interference between propagating modes in individual cavities.

As will be appreciated, where waveguides 100 with more than two modes are used in device 200, the total number of filtered frequencies will increase. The n waveguides 100 of the device may all provide the same number of transmission minima (e.g. two, as discussed above). Alternatively, a mix of waveguides 100 having different numbers of transmission minima can be cascaded in a device 200. A designer of device 200 may select an appropriate combination of waveguides for a particular implementation, for example optimising the size and shape of the device 200 for spatial restrictions in the intended use of the device 200.

Thus the waveguides 100 of the present disclosure provide a new class of compact and highly selective dual-mode cavity filters employing signal-interaction in individual basic sections. In contrast to conventional dual-mode filters, N order filters with N real-frequency transmission zeros can be realized, without the use of direct input-to-output coupling, dangling resonators, cumbersome cross-coupling architecture, or over-moded cavities.

FIG. 7A illustrates a further example of a waveguide 100. FIG. 7B shows the frequency response of the waveguide 100 shown in FIG. 7A. In this example, the waveguide is a cuboidal dual-mode waveguide. As with the waveguides discussed above, waveguide 100 of FIG. 7A comprises an input node 104 and an output node 105. In the illustrated example, the nodes 104, 105 are formed by input/output waveguides.

In this example, the input node 104 and output node 105 are rotated with respect to the main body of the waveguide 100. That is, the input node 104 and the output node 105 are configured such that light entering/leaving the waveguide 100 is misaligned with one or more axes of symmetry of the waveguide 100. In the illustrated example, the nodes 104, 105 are rotated with respect to the longitudinal axis of the waveguide 100. The longitudinal axis is the axis running long length of the cuboid from end-to-end (the z-axis in FIG. 7A). In other words, the nodes 104, 105 are rotated around an axis (the x-axis and y-axis respectively in FIG. 7A) that is perpendicular to the longitudinal axis. In other examples, only one of the input node 104 and output node 105 is rotated. Such rotations alter the amplitude and/or phase relationship between the coupled modes in the wave guide 100, changing the position of the transmission (and reflection) minima. Therefore rotating one or both of the nodes 104, 105 provides another option for positioning the nodes for tuning the frequency response of the waveguide 100. This may be particularly useful for example where unrotated nodes 104, 105 would have to be very close together to provide desired transmission minima. It may be difficult to manufacture nodes 104, 105 so close together. Rotation of the nodes 104, 105 may allow the desired transmission minima to be achieved with nodes 104, 105 further apart from each other, making manufacture of the waveguide 100 easier. In addition, the rotation of the nodes 104, 105 can act as a perturbation, coupling the degenerate modes. In some examples, the perturbation of the waveguide 100 is provided solely by the rotation of one or both of the nodes 104, 105. In other examples, an additional perturbation or perturbation structure 108 is also used. In the waveguide illustrated in FIG. 7A, an additional perturbation is provided by the rounded corner in the otherwise square cross-section of the waveguide 100.

A similar approach can be taken to couple waveguides 100 into a device 200. FIG. 8A illustrates waveguide device 200 comprising a cascade of two cuboidal waveguides 100. In this example, the input node 104-1 of a first waveguide 100-1 is in a sidewall 103-1 of the first waveguide 100-1. The output node 105-1 of the first waveguide 101-1 is in a second end 102-1 of the first waveguide 100-1. Propagation of waves through such a waveguide 100-1 therefore has both an azimuthal component and a longitudinal component. Similarly, the input node 104-2 of the second waveguide 100-2 is in a first end 101-2 of the second waveguide 100-2. The output node 105-2 of the second waveguide 100-2 is in a sidewall 103-2 of the second waveguide 100-2.

In the illustrated example, the output node 105-1 of the first waveguide 100-1 and the input node 104-2 of the second waveguide 100-2 are formed of a common connecting waveguide 201. Connecting waveguide 201 couples electromagnetic waves from the first waveguide 100-1 into the second waveguide 100-2.

As with the waveguide 100 of FIG. 7A, the first input node 104-1 and second output node 105-2 of device 200 are formed of rotated waveguides. In addition, in the illustrated example the connecting waveguide 200 is rotated. These rotations alter the phase relationships between coupled degenerate modes in the waveguides 100-1, 100-2. Thus these rotations provide additional degrees of freedom in designing the device 100 with particular frequencies of transmission minima. The frequency response of the example waveguide device 200 of FIG. 8A is shown in FIG. 8B. As can be seen, there are four transmission minima, comprising two transmission minima from each waveguide 100-1, 100-2. As will be appreciated, device 200 could be extended by the inclusion of further waveguides 100, coupled for example by respective connecting waveguides 201, resulting in further transmission minima.

The above discussion has focused primary on dual-mode waveguides 100. However, waveguides 100 may be constructed with more than two orthogonal modes, leading to more than two transmission (and reflection) minima. Using a single waveguide to filter larger numbers of frequencies may reduce the overall size of a device needed for filtering. The number of orthogonal modes, and hence the number of transmission minima, is related to the number of planes of symmetry of the waveguide 100.

FIGS. 9 and 10 demonstrate an example of a multi-mode waveguide 100, in this case comprising three orthogonal modes.

FIG. 9A illustrates a cubic waveguide 100, comprising an input node 104 and output node 105. In this example the input node and output node are formed by respective input/output waveguides. The nodes 104, 105 are aligned with a longitudinal axis of the waveguide 100. As in FIG. 7A, the waveguide 100 of FIG. 9A comprises a rounded corner running the length of the waveguide which provides the perturbation 108.

FIG. 9B illustrates the frequency response of the cubic waveguide 100 of FIG. 9B. As can be seen, only two transmission minimum are present in the illustrated frequency range. A third transmission minima occurs at a much higher frequency.

FIG. 10A illustrates an alternative cubic waveguide 100 which can reduce the frequency of the third transmission minimum. In this case, the input and output nodes 104, 105 are again formed of input/output waveguides, but now are rotated with respect to the longitudinal axis (z-axis in FIG. 10A). The waveguide 100 also comprises a perturbation structure 108 formed of a metal cylinder in a surface of the waveguide 100. The perturbation structure 108 breaks the spatial symmetry between the degenerate TE11 modes of the waveguide 100, and the TM mode. The rotation of the nodes and the metal cylinder provide tuning of the mode that is polarised in the longitudinal direction (the z-axis in the FIG. 7A). As a result, the frequency of the third transmission minimum is reduced to be close the other two minima, which is likely to be preferable in practical applications. Additionally or alternatively, metal structures such as metal cylinders may be added on waveguide faces opposite the input node 104 and/or output node 105 to provide frequency tuning of the other two minima. Such structures provide the designer additional flexibility in designing the waveguide 100 to meet particular filtering needs.

FIG. 10B shows the frequency response of the cubic waveguide 100 of FIG. 10A. The interference between the longitudinal waves and azimuthal waves caused by the coupling of the TE11 modes and the TM mode generates three transmission minima.

In the examples described above, the waveguides 100 have been illustrated as solid core waveguides. As will be appreciated, any of the waveguides 100 may additionally comprise a cladding material. Furthermore, any of the waveguides 11 may be hollow/air-filled waveguides, and/or may be loaded or partially loaded. For example, the waveguides 100 may be loaded by a metallic or dielectric material.

FIGS. 11A and 11B illustrate an example of a partially loaded waveguide 100. FIG. 11A shows a top-down view of the waveguide 100. FIG. 11B shows a side view of the waveguide 100. The waveguide 100 comprises an input node 104 and output node 105, in this case formed of quarter wavelength short stub coaxial lines. In the illustrated example the input node 104 is azimuthally separated from the output node 105 by an angle of 90° The waveguide 100 comprises waveguide material 301 for transmitting electromagnetic waves. The waveguide further comprises a dielectric puck 302 of permittivity>1, topped with a metal disc 303. The inclusion of the dielectric puck 302 and metal disc 303 as loading materials reduces the frequencies of the dominant three degenerate modes, allowing the size of the waveguide 100 to be reduced. The waveguide 100 further comprises a metal disc 304 in a top portion of the waveguide 100 to provide further tuning control of one of the three degenerate dominant modes. In other examples a recess in the waveguide material in the top portion may be used to provide tuning of one of the modes. FIG. 11C shows the modelled frequency response of the waveguide 100 of FIGS. 11A and 11B. CM represents the theoretical response, and EM represents the finite element method modelled response. The results show two transmission zeros at defined frequencies and three reflection zeros. The third transmission zero is at infinity. To bring the third transmission zero to a frequency closer to the passband, the angle between the input node 104 and output node 105 could be changed to a non-90° angle, breaking symmetry and introducing weak couplings between the input and output and the waveguide 100 itself. When cascading multiple cavities 100 to build waveguide devices 200 which provide higher order filtering, the designer can still realise N transmission zeros by breaking symmetry (introducing weak coupling between the input and output) of the individual waveguides 100 rather than the changing the position of the input node 104 and output node 105.

FIG. 12 illustrates an alternative example of a waveguide device 200. In this example the device 200 is formed of a plurality of spherical waveguides 100. Each spherical waveguide 1011 has three modes at the fundamental frequency, and therefore can provide three transmission minima. Each waveguide 100-n has a respective input node 104-n and output node 105-n. For clarity not all nodes are illustrated in the figure. An input node 104-1 of the first waveguide 100-1, formed of an input waveguide, acts as an input to the device 200. An output node 105-5 of the fifth waveguide 100-5, formed of an output waveguide, acts as an output to the device 200. The respective input nodes 104-n and output nodes 105-n of waveguides 100-1, 100-2, 100-4, and 100-5 are separated by an azimuthal angle of 90°. Input node 104-3 of the third waveguide 100-3 is separated from the respective output node 105-3 by an azimuthal angle of 180°. In other examples, different angles may be used. In addition, other examples may use fewer or more waveguides 100 and/or may use one or more waveguides of different shapes. The concepts of the present disclosure allow the designer of the device 200 to select an optimum combination of waveguides and waveguide properties in a cascade with a shape suited to an intended use of the waveguide. For example, for space applications, the designer may optimise the device 200 to reduce the overall size and weight of the device 200.

### The Following Clauses Define Further Statements of Invention:

1. A dual-mode waveguide, the waveguide configured to support two degenerate modes of electromagnetic fields, the waveguide comprising:
a first end, a second end, and at least one sidewall connecting the first end and the second end;
an input node configured to couple electromagnetic fields into the waveguide;
an output node configured to couple electromagnetic fields out of the waveguide; and
a perturbation configured to couple the two degenerate modes within the waveguide;
wherein the input node and the output node are located in the at least one sidewall such that the coupled degenerate modes form an elliptically or circularly-polarised wave within the waveguide with two transmission minima.
2. The waveguide of clause 1, wherein the azimuthal angle between the input node and the output node is selected based on desired frequencies for the two real-frequency minima.
3. The waveguide of clause 2, wherein the desired frequencies are symmetric with respect to a resonant frequency of the waveguide.
4. The waveguide of clause 3, wherein the azimuthal angle between input node and the output node is 90°.
5. The waveguide of clause 2, wherein the desired frequencies are asymmetric with respect to a resonant frequency of the waveguide.
6. The waveguide of clause 5, wherein azimuthal angle between the input node and the output node less than 90°, or in the range 91° to 179°, or more than 180°.
7. The waveguide of any preceding clause, wherein the input node and output node are at the same position along a longitudinal axis, the longitudinal axis extending the length of the waveguide between the first end and the second end.
8. The wave guide of any of clauses 1 to 6, wherein the input node and the output node are separated along a longitudinal axis by a distance of less than half of a resonant wavelength of the waveguide, the longitudinal axis extending the length of the waveguide between the first end and the second end.
9. The waveguide of any preceding clause, wherein the perturbation comprises a perturbation structure extending at least a majority of the length of the waveguide between the first end and the second end.
10. The waveguide of clause 9, wherein the azimuthal angle between the perturbation structure and the input node is equal to the azimuthal angle between the perturbation structure and the output node.
11. The waveguide of clause 9, the azimuthal angle between the perturbation structure and the input node is less than or more than the azimuthal angle between the perturbation structure and the output node.
12. The waveguide of any of clauses 9 to 11, wherein the perturbation structure is formed by an irregularity in the cross-sectional shape of the waveguide.
13. The waveguide of clause 12, wherein the perturbation structure is or comprises a step extending from an outer surface of the waveguide.
14. The waveguide of any of clauses 9 to 13, wherein the perturbation structure is a first perturbation structure, and wherein the waveguide further comprises a second perturbation structure, the second perturbation structure separated from the first perturbation structure by an azimuthal angle of 180°.
15. The waveguide of any of clauses 1-8, wherein the perturbation is provided by an asymmetry in a cross-section of the waveguide, the cross-section perpendicular to a longitudinal axis, the longitudinal axis extending the length of the waveguide between the first end and the second end.
16. The waveguide of clause 15, wherein the cross-section is rectangular.
17. The waveguide any of clauses 1 to 15, wherein the waveguide is a cylindrical waveguide.
18. The waveguide of any of clauses 1 to 14, wherein the waveguide is square waveguide.
19. The waveguide of clause 16 or 18, wherein the one or more sidewalls comprise four sidewalls, and wherein the input node is located in a first sidewall of the four sidewalls, and the output node is located in a second sidewall of the four sidewalls.
20. The waveguide of any preceding clause, wherein the fundamental resonant frequency of the waveguide is in the microwave range of the electromagnetic spectrum.
21. A waveguide device comprising n waveguides, each of the n waveguides being a waveguide according to any of clauses 1 to 20, wherein the n waveguides are connected in a cascade in which the output node each waveguide in the cascade is coupled to the input node of the subsequent waveguide in the cascade to form a waveguide device with N=2n transmission minima.
22. The waveguide device of clause 18, wherein the device is a waveguide filter, a polarizer, a multiplexer, a balance network, a directional coupler, or a filtering antenna.
23. A method of filtering one or more frequencies from an electromagnetic field, the method comprising coupling the electromagnetic field into a waveguide or waveguide device according to any of clauses 1 to 22.
24. A multi-mode waveguide, the waveguide configured to support at least two degenerate modes of electromagnetic fields, the waveguide comprising:
   an input node configured to couple electromagnetic fields into the waveguide;
   an output node configured to couple electromagnetic fields out of the waveguide;
   a perturbation configured to couple the at least two degenerate modes within the waveguide;
   wherein the input node and the output node are positioned such that an angle between a first vector from the input node to a centre point of the waveguide and a second vector from the centre point to the output node is less than 170°, wherein the centre point is the geometrical centre of an internal volume of the waveguide, such that the coupled degenerate modes form a wave within the waveguide with at least two transmission minima.

1. A multi-mode waveguide, the waveguide configured to support at least two degenerate modes of electromagnetic fields, the waveguide comprising:
an input node configured to couple electromagnetic fields into the waveguide;
an output node configured to couple electromagnetic fields out of the waveguide;
a perturbation configured to couple the at least two degenerate modes within the waveguide;
wherein the input node and the output node are positioned such that the coupled degenerate modes form clockwise and counter-clockwise propagating waves within the waveguide with at least two transmission minima.

2. The multi-mode waveguide of claim 1, wherein the input node and the output node are positioned such that an angle between a first vector from the input node to a centre point of the waveguide and a second vector from the centre point to the output node is less than 170°, wherein the centre point is the geometrical centre of an internal volume of the waveguide, such that the coupled degenerate modes form the clockwise and counter-clockwise propagating waves within the waveguide with the at least two transmission minima.

3. The waveguide of claim 1, wherein the waveguide comprises a first end, a second end, and at least one sidewall connecting the first end and the second end; and
wherein at least one of the input node and the output node is located in the at least one sidewall.

4. The waveguide of claim 3, wherein both the input node and output node are located in the at least one sidewall such that the coupled degenerate modes form an elliptically or circularly-polarised wave within the waveguide with at least two transmission minima.

5. The waveguide of claim 4, wherein the at least one sidewall comprises a plurality of sidewalls, and wherein the input node is located in a first sidewall of the plurality of sidewalls, and the output node is located in a second sidewall of the plurality of sidewalls.

6. The waveguide of claim 3, wherein one of the input node or output node is located in one of the first end and second end.

7. The waveguide of claim 1, wherein a position of the input node and/or output node is selected based on desired frequencies for the at least two transmission minima; or
the waveguide of any preceding claim dependent on or from claim 2, wherein the angle between the first vector and the second vector is selected based on desired frequencies for the at least two transmission minima.

8. The waveguide of claim 7, wherein the desired frequencies are symmetric with respect to a resonant frequency of the waveguide.

9. The waveguide of claim 8, wherein the or an azimuthal angle between input node and the output node is 90°.

10. The waveguide of claim 7, wherein the desired frequencies are asymmetric with respect to a resonant frequency of the waveguide.

11. The waveguide of claim 10, wherein the or an azimuthal angle between the input node and the output node less than 90°, or in the range 91° to 179°, or more than 180°.

12. The waveguide of claim 1, wherein the input node and output node are at the same position along a longitudinal axis of the waveguide.

13. The waveguide of claim 1, wherein the input node and the output node are separated along a longitudinal axis of the waveguide by a distance of less than half of a resonant wavelength of the waveguide.

14. The waveguide of claim 1, wherein the perturbation comprises a perturbation structure extending at least a majority of the length of the waveguide along a longitudinal axis of the waveguide.

15. The waveguide of claim 14, wherein the azimuthal angle between the perturbation structure and the input node is equal to the azimuthal angle between the perturbation structure and the output node.

16. The waveguide of claim 14, the azimuthal angle between the perturbation structure and the input node is less than or more than the azimuthal angle between the perturbation structure and the output node.

17. The waveguide of claim 14, wherein the perturbation structure is formed by an irregularity in the cross-sectional shape of the waveguide.

18. The waveguide of claim 17, wherein the perturbation structure is or comprises a step extending from an outer surface of the waveguide.

19. The waveguide of claim 14, wherein the perturbation structure is a first perturbation structure, and wherein the waveguide further comprises a second perturbation structure, the second perturbation structure separated from the first perturbation structure by an azimuthal angle of 180°.

20. The waveguide of claim 1, wherein the perturbation comprises one or more tuning elements, the tuning elements adjustable to control the coupling between degenerate modes in the waveguide, and optionally wherein the tuning elements comprise tuning screws.

21. The waveguide of claim 1, wherein the input node and/or output node are configured such that light entering/leaving the waveguide is misaligned with one or more axes of symmetry of the waveguide.

22. The waveguide of claim 1, wherein the perturbation is provided by an asymmetry in a cross-section of the waveguide, the cross-section perpendicular to a longitudinal axis of the waveguide.

23. The waveguide of claim 23, wherein the cross-section is rectangular.

24. The waveguide of claim 1, wherein the waveguide is a dual-mode waveguide configured to support two degenerate modes.

25. The waveguide of claim 23, wherein the waveguide is a cylindrical waveguide or a cuboidal waveguide.

26. The waveguide of claim 1, wherein the waveguide is a triple-mode waveguide configured to support three degenerate modes.

27. The waveguide of claim 26, wherein the waveguide is a cubic waveguide.

28. The waveguide of claim 1, wherein the waveguide is a spherical waveguide.

29. The waveguide of claim 1, wherein the fundamental resonant frequency of the waveguide is in the microwave range of the electromagnetic spectrum.

30. A waveguide device comprising n waveguides, each of the n waveguides being a waveguide according to claim 1, wherein the n waveguides are connected in a cascade in which the output node each waveguide in the cascade is coupled to the input node of the subsequent waveguide in the cascade to form a waveguide device with a plurality of transmission minima.

31. The waveguide device of claim 30, wherein the device is a waveguide filter, a polarizer, a multiplexer, a balance network, a directional coupler, or a filtering antenna.

32. A method of filtering one or more frequencies from an electromagnetic field, the method comprising coupling the electromagnetic field into a waveguide or waveguide device according to claim 1.
